(19) United States
(12) Patent Application Publication
(10) Pub. No.: US 2021/0148590 A1
(43) Pub. Date: May 20, 2021

(54) CLIMATE CONTROLLER FOR MEDIA LIBRARY

(71) Applicant: QUANTUM CORPORATION, San Jose, CA (US)

(72) Inventors: Mathew Aschenberg, Centennial, CO (US); Turguy Goker, Vista, CA (US); Robert Yang, Greenwood Village, CO (US); Scott M. Rockwell, Aurora, CO (US); Christian A. Todd, Parker, CO (US); James P. Peng, Santa Maria, CA (US); Christopher Derby, Colorado Springs, CO (US); Getachew Asefaw, Aurora, CO (US)

(21) Appl. No.: 16/688,115

(22) Filed: Nov. 19, 2019

(51) Int. Cl. F24F 11/30; G05D 22/02; F24F 11/62; B60H 1/00

(52) U.S. Cl. CPC F24F 11/30; G05D 22/02; F24F 2110/20; B60H 1/00785; F24F 11/62

(57) ABSTRACT

A climate controller for a media library having a library interior includes one or more of a temperature sensor, a temperature controller, a humidity sensor, and a humidity controller. The temperature sensor senses an inside temperature within the library interior. The temperature controller is positioned within the library interior. The temperature controller controls the temperature within the library interior based at least partially upon the temperature information. The temperature controller can include one of a temperature increaser and a temperature decreaser. The humidity sensor senses an inside humidity within the library interior and generates humidity information. The humidity controller is positioned within the library interior. The humidity controller controls the humidity within the library interior based at least partially upon the humidity information. In various embodiments, the humidity controller cooperates with the temperature controller to control climate conditions within the library interior based on climate conditions outside of the library interior.

### BACKGROUND

Automated media libraries, such as media libraries, for example, are sensitive to environmental conditions, and as such data media drive specifications have specified operating conditions to increase the likelihood of better operation and storage of tape media. Historically, media libraries have been designed for and installed in a homogeneous, tightly climate-controlled data center.

Market demands on data storage devices are increasingly requiring a wider climate tolerance. Hence, data centers are moving toward on open-air cooling model, which while maintaining a favorable average temperature for tape media storage, allows for the temperatures to swing between extremes which are not tolerated well by tape storage technology. Further, because tape media substrate can be hygroscopic, the dimensional stability of tape media is significantly affected by the ambient humidity and/or dew point levels.

This climate control problem is further exacerbated as the data density is expected to double with each successive generation of media drives. As the data density is increased, the sensitivity to temperature, humidity and dew point extremes is intensified due to tape media expansion and contraction.

Additionally, climate-controlled automated media libraries present a unique challenge when a service action requires opening the media library. Conventional climate controls typically reduce in the internal temperature of the media library below the dew point of the external ambient environment. Opening the media library when ambient conditions are above approximately 20° C. can cause condensation to form on the interior of the library. Condensation can damage electronic components, media drives and tape media.

However, as the industry has started to implement open-air data centers, the geographical location of such data centers can dictate the climate for the data center, resulting in humidity and/or dew point being largely left uncontrolled. In these locations, either tape media has been removed from the data center altogether, or the data center has opted to provide a dedicated environmentally controlled structure around the library.

Humidity control, in the Information Technology sector, relies on a few specific technologies. Commercially available humidity control devices typically utilize an air conditioner compressor-based chiller to lower humidity. Conversely, raising the humidity is often accomplished using a steam injector. These solutions require reserves of filtered water to humidify an enclosure. In large scale deployments this is often accomplished by plumbing water through expensive filtering systems. Without filtering, minerals in the water will scale and damage the media library, including electronic components within the media library.

### SUMMARY

The present invention is directed toward a climate controller for a media library. The media library includes a library interior and a media drive positioned within the library interior. In various embodiments, the climate controller includes a temperature sensor and a temperature controller. The temperature sensor senses an inside temperature within the library interior. The temperature controller can receive temperature information from the temperature sensor and/or can control the temperature within the library interior based at least partially upon the temperature information. Further, the temperature controller includes one of a temperature increaser and a temperature decreaser.

In some embodiments, the temperature controller includes one of an air conditioner, a chilled water cooler, a Peltier cooler and a vortex cooler.

In certain embodiments, the climate controller also includes a humidity controller that controls an inside humidity within the library interior.

In various embodiments, the humidity controller cooperates with the temperature controller to regulate an inside dew point within the library interior.

In some embodiments, the climate controller also includes a humidity sensor that senses the inside humidity and generates humidity information. In some such embodiments, the humidity controller controls the inside humidity based at least in part on the humidity information.

In certain implementations, the humidity controller includes one of a solid polymer membrane humidity controller and an ionic membrane humidity controller.

In various embodiments, the temperature controller selectively controls the inside temperature of the library interior based on an outside dew point that is outside of the library interior.

In some embodiments, the temperature controller selectively adjusts the inside temperature of the library interior so that the inside temperature is greater than an outside dew point that is outside of the library interior.

In various implementations, the temperature controller adjusts the inside temperature within the library interior based on a predetermined schedule.

In certain embodiments, the temperature controller adjusts the inside temperature within the library interior based on a command of a user of the media library.

In some embodiments, the temperature controller includes both a temperature increaser and a temperature decreaser.

The present invention is also directed toward a media library having a library interior and a climate controller positioned at least partially within the library interior.

The present invention is also directed toward a climate controller for a media library. The media library includes a library interior and a media drive positioned within the library interior. In certain embodiments, the climate controller includes a humidity sensor and a humidity controller. The humidity sensor senses an inside humidity within the library interior. Further, the humidity sensor can generate humidity information. The humidity controller can be positioned within the library interior or outside of the library interior. In various embodiments, the humidity controller controls the humidity within the library interior based at least partially upon the humidity information.

In some embodiments, the humidity controller includes one of a solid polymer membrane humidity controller and an ionic membrane humidity controller.

In certain embodiments, the humidity controller adjusts the inside humidity within the library interior based on a predetermined schedule.

In various implementations, the humidity controller adjusts the inside humidity within the library interior based on a command of a user of the media library.

In some embodiments, the climate controller also includes a temperature controller that controls an inside temperature within the library interior based on an outside dew point that is outside of the library interior

The present invention is also directed toward a climate controller for a media library having a library interior. In some embodiments, the climate controller includes a temperature sensor, a temperature controller, a humidity sensor, and a humidity controller. The temperature sensor senses an inside temperature within the library interior. The temperature controller can be positioned within the library interior or outside of the library interior. The temperature controller controls the temperature within the library interior based at least partially upon the temperature information. The temperature controller can include one of a temperature increaser and a temperature decreaser. The humidity sensor senses an inside humidity within the library interior and generates humidity information. The humidity controller can be positioned within the library interior or outside of the library interior. The humidity controller controls the humidity within the library interior based at least partially upon the humidity information. In various embodiments, the humidity controller cooperates with the temperature controller to control climate conditions within the library interior based on climate conditions outside of the library interior.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a top view of one embodiment of an automated media library having features of the present invention, shown with a top wall omitted so structures within the automated media library are visible, including a temperature controller and a humidity controller;

FIG. 1B is a top view of another embodiment of the automated media library, shown with a top wall omitted so structures within and outside of the automated media library are visible, including a temperature controller and a humidity controller;

FIG. 2 is a perspective view of one embodiment of the humidity controller;

FIG. 3A is a front view of one embodiment of the automated media library shown in a closed position including a graphical user interface prior to controlling a climate within a library interior;

FIG. 3B is a front view the automated media library illustrated in FIG. 3A including the graphical user interface following controlling of the climate within the library interior;

FIG. 4 is a perspective view of an automated media library and a library enclosure having features of the present invention; and

FIG. 5 is a perspective view of an automated media library and another embodiment of the library enclosure.

### DESCRIPTION

Embodiments of the present invention are described herein in the context of climate control systems for automated media libraries (sometimes also referred to herein as “media library”). As provided herein, the media library as a whole, as well as media drives and tape cartridges housed within the media library can better maintain peak performance and longevity.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

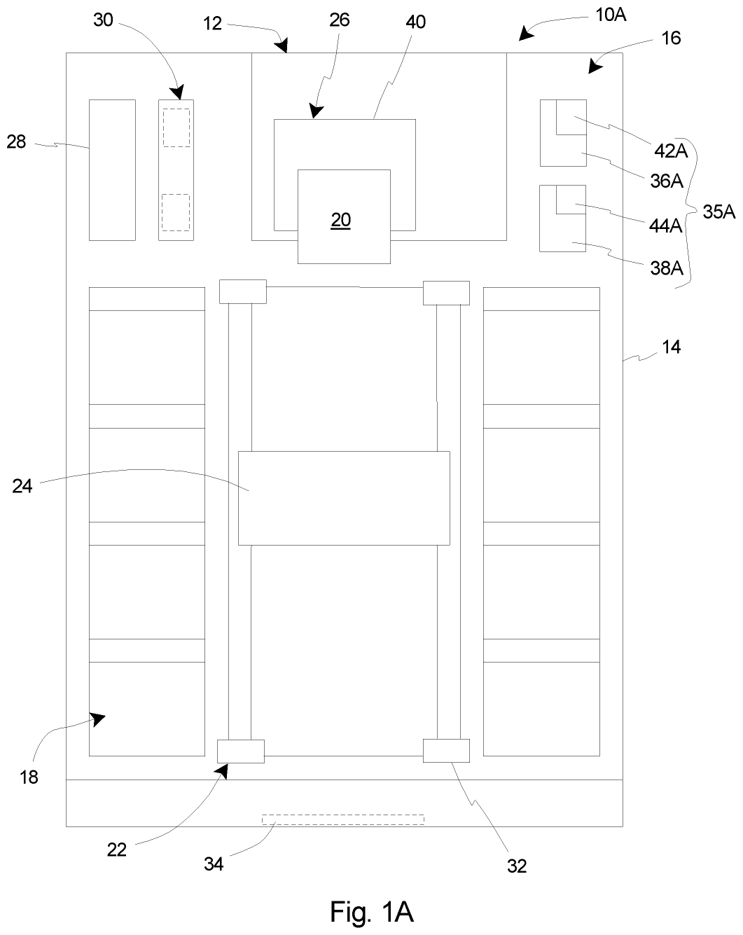

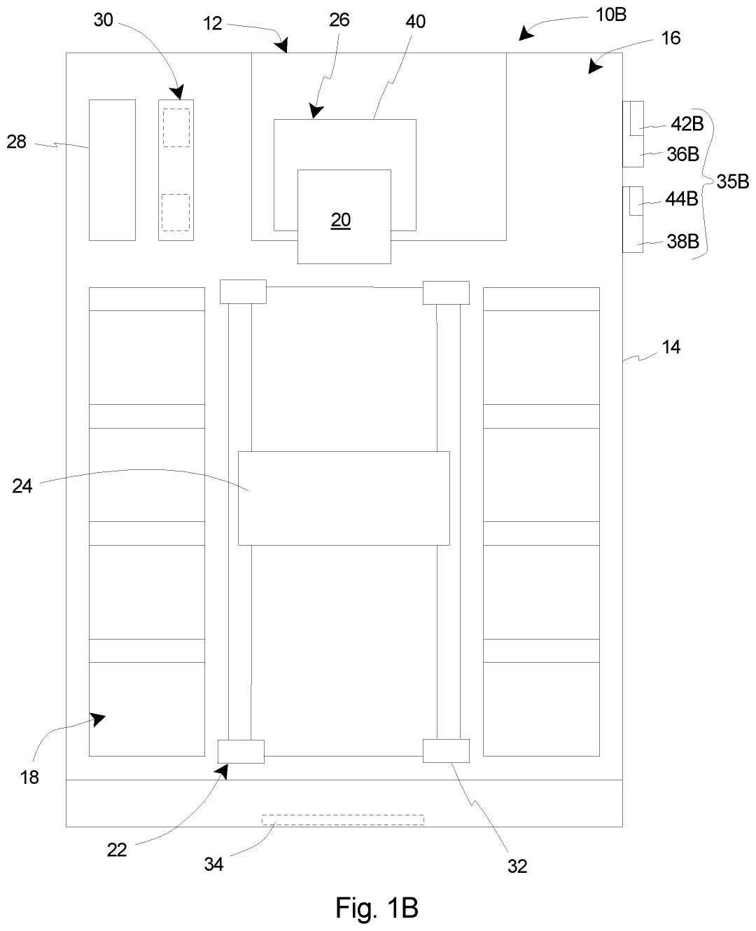

FIG. 1A is a simplified schematic top view illustration of a media library 10A, e.g., a tape library in certain embodiments, including a media drive system 12, e.g., a media drive system in certain embodiments, having features of the present invention. In FIG. 1A, a top cover (not shown) has been omitted for clarity so that the interior of the media library 10A is visible. The design of the media library 10A can be varied as desired. In particular, the media library 10A can have any suitable design that is capable of storing a plurality of media cartridge. More specifically, it is noted that the media library 10A illustrated in FIG. 1A is just one non-exclusive example of a media library 10A usable with the present invention, and no limitations are intended based on the specific type and/or size of the media library 10A shown in FIG. 1A. Additionally, although the media library 10A shown and described relative to FIG. 1A is specifically shown and/or described at times as a tape cartridge library or tape library, it is understood that the present invention is equally applicable for use with any other suitable types of libraries using other types of media cartridge, such as optical disks, magnetic disk drives, emulated or virtual media drives, etc., as non-exclusive examples. However, for ease of discussion, FIG. 1A and certain other Figures herein are sometimes described using tape cartridges as the applicable media cartridge, although this is not intended to restrict or limit the present invention in this manner.

In various embodiments, as illustrated in FIG. 1A, the media library 10A can include one or more of: (i) a library housing 14 that defines an library interior 16, (ii) a plurality of storage slots 18 that are each configured to receive and selectively retain (and store) a media cartridge 20, e.g., a tape cartridge in certain embodiments (also sometimes referred to herein simply as a “media cartridge”), (iii) a rack assembly 22, (iv) a media cartridge retrieval assembly 24 (also sometimes referred to herein as a “retrieval assembly”), (v) the media drive system 12 including one or more media drives 26, e.g., tape drives in certain embodiments, (vi) a power supply 28, (vii) a control system 30, (viii) one or more racks 32, (ix) a graphical user interface 34 (also sometimes referred to herein as a “GUI”), (x) a climate controller 35A, which can include one or more temperature controllers 36A (only one temperature controller 36A is illustrated in FIG. 1A), and/or one or more humidity controllers 38A (only one humidity controller 38A is illustrated in FIG. 1A).

The library housing 14 is configured to retain various components of the tape library 10A. For example, in the embodiment illustrated in FIG. 1A, the plurality of storage slots 18, the rack assembly 22, the retrieval assembly 24, the one or more media drives 26 of the media drive system 12, the power supply 28, the control system 30, the rack(s) 32, the temperature controller 36A and the humidity controller 38A can all be received and retained at least substantially, if not entirely, within the library interior 16 that is defined by the library housing 14. As provided herein, in other embodiments, one or more of the aforementioned structures can alternatively be positioned outside of the library interior 16. Additionally, as illustrated in FIG. 1A, the library housing 14 can be rigid and have a substantially rectangular-shaped cross-section. Alternatively, the library housing 14 can have another suitable shape or configuration. For example, the library housing 14 can have a substantially square-shaped or any other suitable shaped cross-section. Further, the library housing 14 may be constructed of any number of conventional materials such as, for example, those utilized in industry standard rack mount cabinets.

In the embodiment shown in FIG. 1A, the plurality of storage slots 18 can be positioned within the library housing 14, with the storage slots 18 being configured to receive and retain (and store) the media cartridge(s) 20. More particularly, in various embodiments, each of the storage slots 18 is configured to receive and retain a single media cartridge 20. It is noted that no media cartridge 20 is shown as being retained within the storage slots 18 in FIG. 1A for clarity. In various embodiments, the tape library 10A can include any suitable number of storage slots 18, and/or the tape library 10A can be designed to retain any suitable number of media cartridges 20. Alternatively, the storage slots 18 can be arranged in a different manner than is illustrated and described relative to FIG. 1A.

The design and configuration of the rack assembly 22 can be varied to suit the specific requirements of the tape library 10A. For example, in one non-exclusive embodiment, the rack assembly 22 can include four individual racks 32 that are spaced apart from one another. Additionally, in some embodiments, each rack 32 can be oriented in a generally vertical direction and can extend a height that is sufficient to enable the retrieval assembly 24 to effectively retrieve media cartridge 20 from any of the plurality of storage slots 18. Alternatively, the rack assembly 22 can include a different number of racks 32. For example, in some non-exclusive alternative embodiments, the rack assembly 22 can include two racks 32, three racks 32 or more than four racks 32 that can be spaced apart from one another.

The media storage retrieval assembly 24 selectively, e.g., upon request of a user, retrieves and moves the media cartridge 20 as desired between the storage slots 18 and the media drives 26. In particular, during use, upon receiving a signal from the control system 30 to access a certain media cartridge 20, the retrieval assembly 24 can be manipulated to physically retrieve the requested media cartridge 20 from its associated storage slot 18 in the tape library 10A. Subsequently, the retrieval assembly 24 moves the media cartridge 20 to an appropriate media drive 26, and inserts the media cartridge 20 into a drive housing 40 of the media drive 26 so that the requested read/write operations can be performed. Upon completion of the requested read/write operations, the retrieval assembly 24 can then return the media cartridge 20 to an appropriate storage slot 18.

Additionally, it is appreciated that although a single retrieval assembly 24 is illustrated in FIG. 1A, the tape library 10A can be designed to include more than one retrieval assembly 24. For example, in one non-exclusive alternative embodiment, the tape library 10A can include two retrieval assemblies 24 to function in different portions of the tape library 10A and/or to provide redundancy in the event that one of the retrieval assemblies 24 fails.

The one or more media drives 26 are configured for reading and/or writing data with respect to the media cartridge 20. The number of media drives 26 provided within the media library 10A can be varied to suit the specific requirements of the media library 10A. For example, in certain embodiments, the media library 10A can include three media drives 26 that are stacked substantially one on top of another (with limited spacing therebetween). Alternatively, the media library 10A can include greater than three or fewer than three media drives 26 and/or the media drives 26 can be positioned in a different manner relative to one another. Further, depending on the specific design of the media library 10A, the media drives 26 can be adapted for use with different types of media, such as tape cartridges, optical drives, hard disk drives, etc.

Further, in certain embodiments, the media library 10A can include more than a single media drive system 12 for purposes of providing the one or more media drives 26. For example, in some embodiments, the media library 10A can include a plurality of media drive systems 12, with each media drive system 12 including one or more individual media drives 26. In one such embodiment, the media library 10A can include three individual media drive systems 12, with each media drive system 12 including a single media drive 26, to provide a total of three media drives 26 for the media library 10A. Alternatively, the media library 10A can include any desired number of media drive systems 12 and/or media drives 26.

The power supply 28 provides electrical power in a well-known manner to the one or more media drives 26, the retrieval assembly 24, the control system 30 and/or additional media libraries 10. The power supply 28 can be interfaced with these components as well as with an external power source in a well-known manner using industry standard cabling and connections. Alternatively, the power supply 28 can be interfaced with these components in another manner.

The control system 30 provides the desired and necessary control for general functionality of the media library 10A. The control system 30 can have any suitable design, many of which are well-known in the industry. For example, in one embodiment, the control system 30 can include a standard driver interface unit for receiving digital commands and translating the commands into driving currents, such as step pulses for controlling stepper motors, and/or for controlling the temperature controller 36A and/or the humidity controller 38A. Further, the control system 30 can include a standard programmable general purpose computer formed on a single plug-in card unit and can include a programmed microprocessor or microcontroller, memory, communication interface, control interface, connectors, etc. Alternatively, the control system 30 can have a different design and/or the control system 30 can be positioned within the media library 10A in a different position or manner than that illustrated in FIG. 1A. Further, the control system 30 can also interact with the climate controller 35A to control operation of the climate controller 35A and its components.

Further, as shown, the media library 10A can also include a GUI 34 (illustrated in phantom), e.g., an interactive touchscreen graphical user interface or another suitable graphical user interface, which allows the user to interact with and/or transmit requests or commands to and/or from the media library 10A.

The climate controller 35A controls the climate within the library interior 16. In various embodiments, the climate controller 35A can regulate, adjust, control and/or maintain a specific climate within the library interior 16. In certain embodiments, at various times, the specific climate that is regulated, adjusted, controlled and/or maintained by the climate controller 35A within the library interior 16 can be based on a climate outside of the library interior 16, as described in greater detail herein.

The temperature controller 36A regulates and/or adjusts the temperature within the library interior 16 of the media library 10A. The design and/or particular type of temperature controller 36A included in the media library 10A can vary. In various embodiments, the temperature controller 36A can include at least one of a temperature decreaser and/or a temperature increaser. For example, the temperature controller 36A can include one or more of an air conditioner, a chilled water cooler, a Peltier cooler, a vortex cooler, etc., or any other suitable type of temperature controller(s) that can selectively lower the temperature within the library interior 16. The temperature controller 36A can alternatively (or additionally) include a heating unit that can selectively increase the temperature within the library interior 16. In various embodiments, the temperature controller 36A can have a substantially similar form factor to the rack(s) 32. Alternatively, the temperature controller 36A can utilize other structures within the media library 10A to increase the temperature within the library interior 16. As one non-exclusive example, the temperature controller can cooperate with one or more media drives 26 (or other structures within the media library 10A) to generate additional heat within the library interior 16 by cycling on the media drives 26 (or other structures within the media library 10A) in order to achieve a specific temperature or temperature range within the library interior 16.

In various embodiments, the temperature controller 36A can include one or more temperature sensors 42A (only one temperature sensor 42A is illustrated in FIG. 1A) that can sense an ambient temperature within or outside of the library interior 16. The temperature sensor 42A can generate temperature information that is based on the temperature that is sensed by the temperature sensor 42A. Although the temperature sensor 42A is illustrated in FIG. 1A as being secured to or being integral with the temperature controller 36A, in an alternative embodiment, the temperature sensor 42A can be spaced apart and/or separate from the temperature controller 36A within the library interior 16. Still alternatively, the temperature sensor 42A can be positioned outside of the library interior 16. In another embodiment, a plurality of temperature sensors 42A can be positioned in any suitable location(s), such as within and outside of the library interior 16 of the media library 10A.

In certain embodiments, the temperature controller 36A can receive the temperature information that is generated by the temperature sensor(s) 42A. In one embodiment, this temperature information can be used by the temperature controller 36A to automatically regulate and/or adjust the temperature within the library interior 16 in accordance with predetermined temperature standards set by a user, for example. Such adjustments of the temperature can be made at predetermined time intervals, at predetermined times of the day or night, or at other times when temperature adjustment is needed, as non-exclusive examples. In certain embodiments, adjustments of the temperature can be manually dictated by command of a user at various times as needed, such as prior to opening of the media library 10A or otherwise subjecting the library interior 16 to temperature conditions outside of the library interior 16. Additionally, or in the alternative, the temperature controller 36A can automatically regulate and/or adjust the temperature within the library interior 16 based on a particular climate outside of the library interior 16, as described in greater detail herein.

The humidity controller 38A regulates and/or adjusts the humidity within the library interior 16 of the media library 10A. The design and/or particular type of humidity controller 38A included in the media library 10A can vary. For example, the humidity controller 38A can include any type of humidifier or dehumidifier, such as a solid polymer membrane humidity controller, an ionic membrane humidity controller, or any other suitable type of humidity controller 38A that can selectively change, maintain and/or control the humidity within the library interior 16 of the media library 10A. Certain humidity controllers 38A can remove or add moisture from the air in the library interior 16 by electrolysis when a small voltage is applied. Any suitable number of humidity controllers 38A can be used within the library interior 16.

In various embodiments, the humidity controller 38A can include one or more humidity sensors 44A (only one humidity sensor 44A is illustrated in FIG. 1A) that can sense the humidity within or outside of the library interior 16. Although the humidity sensor 44A is illustrated in FIG. 1A as being secured to or being integral with the humidity controller 38A, in an alternative embodiment, the humidity sensor 44A can be spaced apart and/or separate from the humidity controller 38A within the library interior 16. Still alternatively, the humidity sensor 44A can be positioned outside of the library interior 16. In another embodiment, a plurality of humidity sensors 44A can be positioned in any suitable location(s), such as within and outside of the library interior 16 of the media library 10A.

In certain embodiments, the humidity controller 38A can receive humidity information from the humidity sensor(s) 44A. In one embodiment, this humidity information can be used by the humidity controller 38A to automatically regulate and/or adjust the humidity within the library interior 16 in accordance with predetermined humidity standards set by a user, for example. Such adjustments of the humidity can be made at predetermined intervals, at predetermined times of the day or night, or at other times when humidity adjustment is needed, as non-exclusive examples. In certain embodiments, adjustments of the humidity can be manually dictated by command of a user at various times as needed, such as prior to opening of the media library 10A or otherwise subjecting the library interior 16 to humidity conditions outside of the library interior 16. In other embodiments, the humidity controller 38A can automatically regulate and/or adjust the humidity within the library interior 16 based on a particular climate outside of the library interior 16, as described in greater detail herein.

In various embodiments, the temperature controller 36A, the humidity controller 38A, the temperature sensor 42A and/or the humidity sensor 44A can cooperate with one another to regulate and/or adjust climate conditions within the library interior 16 that is based on the temperature and/or humidity immediately outside of the library interior 16, e.g., immediately outside of the media library 10A. For example, in one embodiment, the temperature controller 36A, the humidity controller 38A, the temperature sensor 42A and/or the humidity sensor 44A can cooperate with one another to regulate and/or adjust a climate within the library interior 16 that is substantially similar or identical to the temperature and/or humidity immediately outside of the library interior 16, e.g., immediately outside of the media library 10A. In one such embodiment, the temperature controller 36A and the humidity controller 38A cooperate with one another to regulate and/or adjust the climate conditions within the library interior 16 to be similar or substantially identical to the climate conditions immediately outside of the library interior 16, e.g., immediately outside of the media library 10A. With this design, when the media library 10A is opened thereby exposing the library interior 16 to environmental conditions outside of the media library 10A, i.e. for service, etc., the temperature and humidity within the library interior 16 can be substantially similar or identical to the temperature and humidity immediately outside of the media library 10A. As a result, the likelihood of condensation forming within the library interior 16 is decreased or eliminated.

Alternatively, or additionally, the temperature controller 36A, the humidity controller 38A, the temperature sensor 42A and/or the humidity sensor 44A can cooperate with one another to regulate and/or adjust climate conditions within the library interior 16 that further decrease the likelihood that condensation will occur when the library interior 16 is subjected to the temperature and humidity conditions outside of the library interior 16. For example, the temperature controller 36A, the humidity controller 38A, the temperature sensor 42A and/or the humidity sensor 44A can cooperate with one another to regulate and/or adjust the climate conditions within the library interior 16 to further decrease the likelihood that condensation will occur within the library interior 16 when exposed to the specific temperature, humidity and/or dew point conditions outside of the library interior 16, as further described herein.

In various embodiments, the media library 10A can be used for long-term storage to maintain the integrity of the media cartridge 20 and its contents, e.g., storage media (not shown), for approximately 10 years or more. For example, the media library 10A can be shut down, with the exception of one or more of the temperature controller 36A, the humidity controller 38A, the temperature sensor 42A and/or the humidity sensor 44A. In certain embodiments, the media library 10A can occasionally be powered up for the purpose of reading and/or rewinding the media cartridge(s) 20. Once read and/or rewound, the media library 10A can return to the powered down state, with the exception of the temperature controller 36A, the humidity controller 38A, the temperature sensor 42A and/or the humidity sensor 44A.

In certain embodiments, the temperature controller 36A can cooperate with the temperature sensor 42A to control and/or maintain a particular temperature or temperature range within the library interior 16, regardless of the temperature outside of the media library 10A. For example, in one embodiment, the temperature controller 36A can maintain the temperature within a range of approximately 16-30° C. Still alternatively, the temperature range can be narrower or wider than 16-30° C. Further, or alternatively, the humidity controller 38A can cooperate with the humidity sensor 44A to control and/or maintain a particular humidity or humidity range within the library interior 16, regardless of the humidity outside of the media library 10A. For example, in one embodiment, the humidity controller 38A can maintain the humidity within a range of approximately 20-60% relative humidity. Still alternatively, the humidity range can be narrower or wider than 20-60% relative humidity. Additionally, or alternatively, the temperature controller 36A can regulate and/or adjust the temperature within the library interior 16 based at least partially on data from the humidity sensor 44A. Somewhat similarly, the humidity controller 38A can regulate and/or adjust the humidity within the library interior 16 based at least partially on data from the temperature sensor 42A.

With the designs provided herein, the media library 10A can automatically (or manually) readjust the temperature and/or humidity of the library interior 16 to a desired operating range once the media library 10A is closed (following servicing, for example) prior to storing or retrieving data from the media cartridge(s) 20. By having full monitoring and control, this process can increase the likelihood of providing a relatively high confidence in the integrity of the data stored.

FIG. 1B is a top view of another embodiment of the automated media library 10B. In this embodiment, the media library functions substantially similar to the media library 10A previously described. However, in the embodiment illustrated in FIG. 1B, at least a portion of the climate controller 35B is positioned outside of the library interior 16. For example, in this embodiment, the temperature controller 36B, the humidity controller 38B, the temperature sensor 42B and the humidity sensor 44B can be positioned outside of the library interior 16. It is further understood that one or more of the temperature controller 36B, the humidity controller 38B, the temperature sensor 42B and the humidity sensor 44B can be positioned in the library interior 16, while one or more of the temperature controller 36B, the humidity controller 38B, the temperature sensor 42B and the humidity sensor 44B can be positioned outside of the library interior 16. Stated another way, FIGS. 1A and 1B show two representative configurations of the positioning of the temperature controller 36B, the humidity controller 38B, the temperature sensor 42B and the humidity sensor 44B, but are not intended to be limiting to only those two configurations. As one non-exclusive example, the temperature controller and the humidity controller can be positioned outside of the library interior 16, while the temperature sensor and the humidity sensor can be positioned within the library interior 16. Still alternatively, part of one or more of the temperature controller, the humidity controller, the temperature sensor and/or the humidity sensor can be positioned within the library interior 16, while part of the temperature controller, the humidity controller, the temperature sensor and the humidity sensor can be positioned outside of the library interior 16.

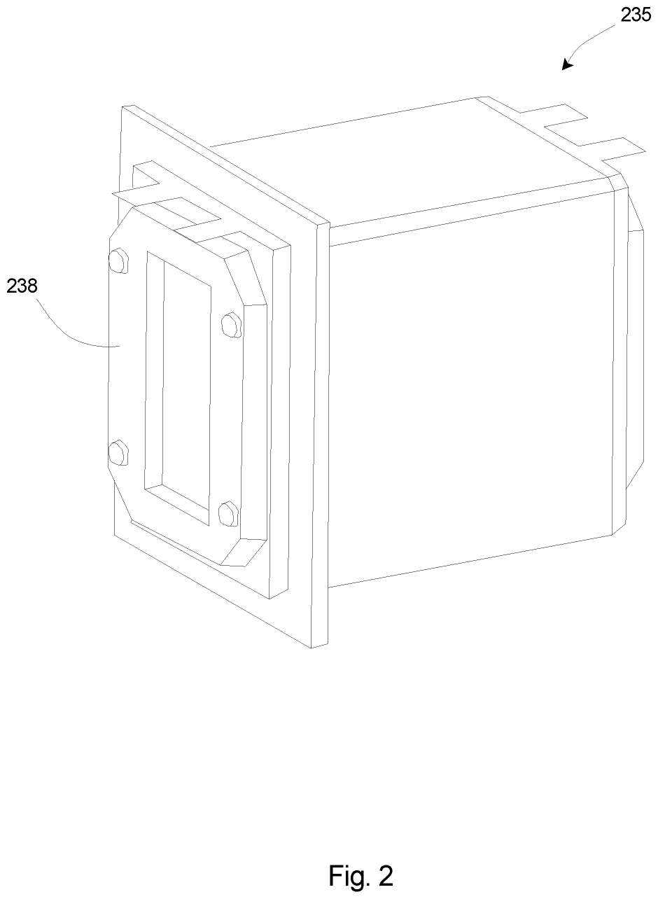

FIG. 2 is a close-up perspective view of one embodiment of at least a portion of the climate controller 235, including the humidity controller 238. In the embodiment illustrated in FIG. 2, the humidity controller 238 can include a solid-state humidifier and/or dehumidifier. For example, in one embodiment, the humidity controller 238 can use a solid polymer electrolyte (SPE) membrane for long-term maintenance-free decreased or increased humidity within the library interior 16 of the media library 10A. In various embodiments, the humidity controller 238 can have a substantially similar form factor to the rack(s) 32 (illustrated in FIG. 1A). Alternatively, other types of solid-state humidifiers and/or dehumidifiers can be included as part of the humidity controller 238. Still alternatively, the humidity controller 238 can be other than a solid-state humidifier and/or dehumidifier.

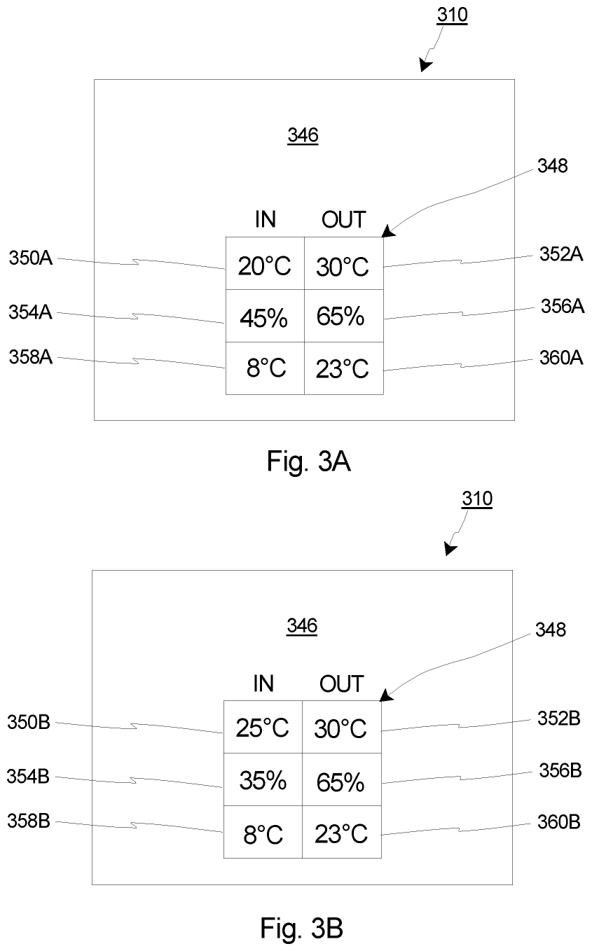

FIG. 3A is a front view of one embodiment of the automated media library 310 shown in a closed position prior to controlling a climate within the library interior 16 (illustrated in FIG. 1A). In the embodiment illustrated in FIG. 3A, the media library 310 includes a library exterior surface 346 and a graphical user interface 348 positioned on or within the library exterior surface 346.

In various embodiments, the graphical user interface 348 can provide a user of the media library 310 with data or other information regarding a current status of temperature, humidity and/or dew point inside and/or outside of the media library. For example, in the embodiment illustrated in FIG. 3A, the graphical user interface 348 can display one or more of an inside temperature 350A (the temperature within the library interior 16), an outside temperature 352A (the temperature outside of the library interior 16), an inside humidity 354A (the humidity within the library interior 16), an outside humidity 356A (the humidity outside of the library interior 16), an inside dew point 358A (the dew point within the library interior 16), and/or an outside dew point 360A (the dew point outside of the library interior 16).

In one embodiment, the graphical user interface 348 can receive information directly or indirectly from the temperature sensor(s) 42 (illustrated in FIG. 1A) and/or the humidity sensor(s) 44 (illustrated in FIG. 1A). This information can then be converted to a visual display for the user or operator of the media library 310A. Further, information from the temperature sensor(s) 42 and/or the humidity sensor(s) 44 can be used to calculate the dew point inside or outside of the library interior 16 of the media library 310. The media library 310 can also (or alternatively) include an audible alarm that sounds when the temperature, humidity and/or dew point within the library interior 16 and/or outside of the library interior 16 exceeds or is below respective predetermined threshold values.

In the embodiment illustrated in FIG. 3A, the inside temperature 350A is 20° C., while the outside dew point 360A is 23° C. If the media library 310 were opened in these conditions, the likelihood that condensation would occur within the library interior 16 would be increased, which could damage various components of the media library 310.

FIG. 3B is a front view of the automated media library 310 illustrated in FIG. 3A, shown in a closed position following controlling the climate within the library interior 16 (illustrated in FIG. 1A). In the embodiment illustrated in FIG. 3B, the media library 310 includes the library exterior surface 346 and the graphical user interface 348 positioned on or within the library exterior surface 346.

In the embodiment illustrated in FIG. 3B, the graphical user interface 348 displays the inside temperature 350B, the outside temperature 352B, the inside humidity 354B, the outside humidity 356B, the inside dew point 358B, and/or the outside dew point 360B. In the embodiment illustrated in FIG. 3B, the climate has been controlled so that the likelihood of condensation occurring after opening the media library 310 is decreased. In this implementation, the inside temperature 350B has been increased via use of the temperature controller 36 (illustrated in FIG. 1A). For example, the inside temperature 350B has been increased to 25° C., while the outside dew point 360B is 23° C. If the media library 310 were opened in these conditions, the likelihood that condensation would occur within the library interior 16 would be decreased since the inside temperature 350B is greater than the outside dew point 360B. Thus, air entering the library interior 16 (upon opening the media library 310) would have a dew point that is lower than the temperature within the library interior 16, thereby inhibiting condensation within the library interior 16. Further, the outside temperature 352B of air entering the library interior 16 (upon opening the media library 310) would be greater than the inside dew point 358B, which would also inhibit condensation within the library interior 16.

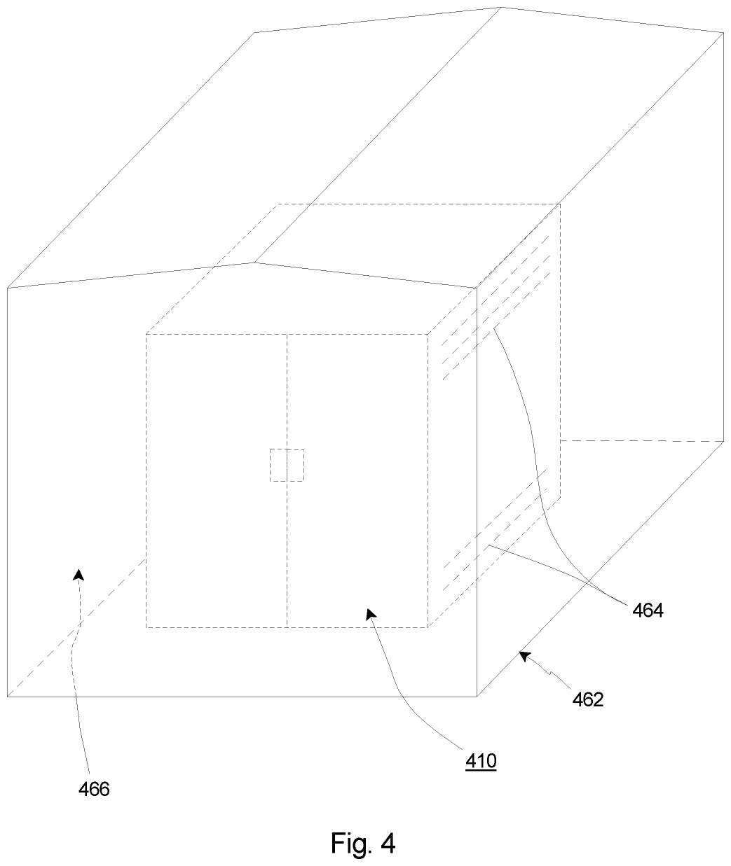

FIG. 4 is a perspective view of one embodiment of the automated media library 410 and a library enclosure 462. In the embodiment illustrated in FIG. 4, the media library 410 can be substantially similar to the media libraries previously shown and/or described. However, in various embodiments, the media library 410 can include one or more library vents 464 that allow air (or other fluid) within the library interior 416 to circulate with air (or other fluid) outside of the library interior 416, as described in greater detail herein. In the embodiment illustrated in FIG. 4, the library enclosure 462 forms a “tent” around media library 410, and substantially encircles, encloses or surrounds substantially the entire media library 410. In one embodiment, the library enclosure 462 can be movable relative to the media library 410, and/or completely removable away from the media library 410.

In various embodiments, the library enclosure 462 can be formed from flexible and/or resilient materials such as nylon, vinyl, cotton, rayon, canvas, felt or polyester, as non-exclusive examples. Alternatively, the library enclosure 462 can be formed from any other suitable material(s) that allow a service person or other user to enter into the library enclosure 462 as appropriate. This material can be supported by frame materials such as plastic, wood, metal, composites or any other suitably rigid materials. The library enclosure 462 can be free-standing or supported by one or more of the floor (or other support structure), the ceiling or wall(s).

The library vents 464 allow the ambient air (or other fluid) inside the library interior 416 to equilibrate with the ambient air (or other fluid) between within the library enclosure 462 (but outside of the media library 410) so that the climate within the library interior 416 and the library enclosure 462 are substantially similar or identical. The positioning and number of library vents 464 can be varied depending upon the configuration of the media library 410.

In this embodiment, the library enclosure 462 can substantially enclose, surround and/or encircle at least a portion of the media library 410. For example, in this embodiment, the library enclosure 462 can create a micro-environment immediately surrounding the media library 410 so that the inside temperature 350A (illustrated in FIG. 3A) can selectively be substantially similar or identical to an enclosure temperature. As used in this embodiment, the enclosure temperature is the temperature outside of the library interior 416 but within an enclosure space 466 between the library enclosure 462 and the media library 410. Alternatively, or in addition, the inside humidity 354A (illustrated in FIG. 3A) can selectively be substantially similar or identical to an enclosure humidity. As used in this embodiment, the enclosure humidity is the humidity outside of the library interior 416 but within the enclosure space 466 between the library enclosure 462 and the media library 410. Still alternatively, or in addition to the foregoing, the inside dew point 358A (illustrated in FIG. 3A) can selectively be substantially similar or identical to an enclosure dew point. As used in this embodiment, the enclosure dew point is the dew point outside of the library interior 416 but within the enclosure space 466 between the library enclosure 462 and the media library 410. With this design, upon opening the media library 410 for service (or other reasons), the likelihood of condensation forming within the library interior 416 is decreased or eliminated.

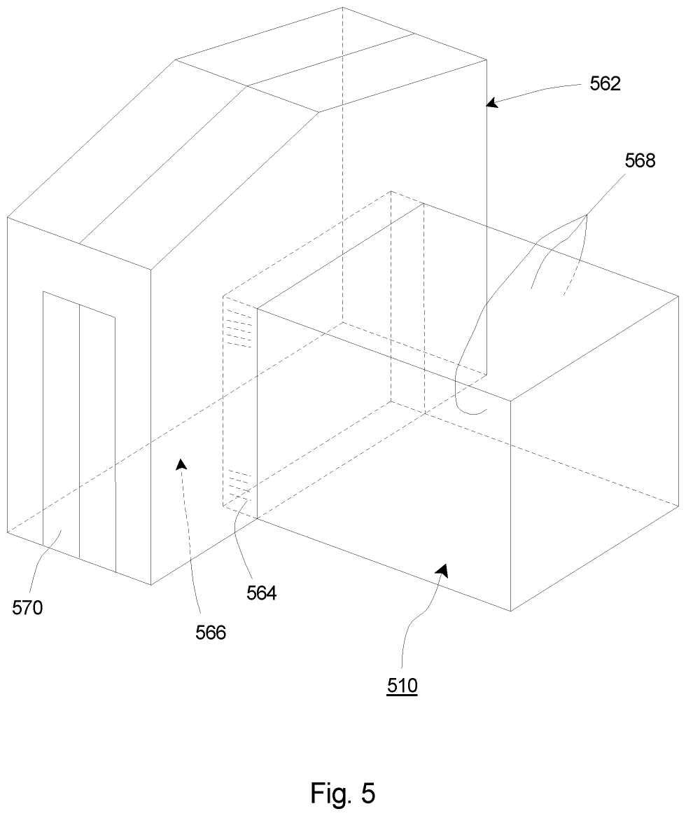

FIG. 5 is a perspective view of one embodiment of an automated media library 510 and another embodiment of the library enclosure 562. In the embodiment illustrated in FIG. 5, the media library 510 can be substantially similar to the media libraries previously shown and/or described. For example, the media library 510 can include one or more library vents 564 that allow air (or other fluid) within the library interior 416 to circulate with air (or other fluid) outside of the library interior 416, as described in greater detail herein. In the embodiment illustrated in FIG. 5, the library enclosure 562 substantially encircles, encloses or surrounds a portion of media library 510. In one embodiment, the portion of the media library 510 that is encircled, enclosed or surrounded can be a portion that is typically opened by a technician, user or other service person. For example, the library enclosure 562 can be secured to one or more library walls 568 and/or other structures (floor, ceiling, etc.) to form a seal around the media library 510 so that air outside of the library enclosure 562 is less likely to interact with air inside of the media library 510 while the media library is open.

In various embodiments, the library enclosure 562 can be formed from flexible and/or resilient materials such as nylon, vinyl, cotton, rayon, canvas, felt or polyester, as non-exclusive examples. Alternatively, the library enclosure 562 can be formed from any other suitable material(s) that allow a service person or other user to enter into the library enclosure 562 as appropriate. This material can be supported by frame materials such as plastic, wood, metal, composites or any other suitably rigid materials. The library enclosure 562 can be free-standing or supported by one or more of the floor (or other support structure), the ceiling or wall(s). In one embodiment, the library enclosure 562 can be movable relative to the media library 510, and/or completely removable away from the media library 510.

The library vents 564 allow the ambient air (or other fluid) inside the library interior 516 to equilibrate with the ambient air (or other fluid) between within the library enclosure 562 (but outside of the media library 510) so that the climate within the library interior 516 and the library enclosure 562 are substantially similar or identical. The positioning and number of library vents 564 can be varied depending upon the configuration of the media library 510.

In this embodiment, the library enclosure 562 can substantially enclose, surround and/or encircle at least a portion of the media library 510. For example, in this embodiment, the library enclosure 562 can create a micro-environment immediately surrounding the media library 510 so that the inside temperature 350A (illustrated in FIG. 3A) can selectively be substantially similar or identical to an enclosure temperature. As used in this embodiment, the enclosure temperature is the temperature outside of the library interior 516 but within an enclosure space 466 between the library enclosure 562 and the media library 510. Alternatively, or in addition, the inside humidity 354A (illustrated in FIG. 3A) can selectively be substantially similar or identical to an enclosure humidity. As used in this embodiment, the enclosure humidity is the humidity outside of the library interior 516 but within the enclosure space 566 between the library enclosure 562 and the media library 510. Still alternatively, or in addition to the foregoing, the inside dew point 358A (illustrated in FIG. 3A) can selectively be substantially similar or identical to an enclosure dew point. As used in this embodiment, the enclosure dew point is the dew point outside of the library interior 516 but within the enclosure space 566 between the library enclosure 562 and the media library 510. With this design, upon opening the media library 510 for service (or other reasons), the likelihood of condensation forming within the library interior 516 is decreased or eliminated.

Further, the library enclosure 562 can also include an enclosure access 570 that allows a technician, user or service person to enter and/or exit the library enclosure 562.

With the designs provided herein, one or more of the following advantages can be achieved. For example, environmental conditions may vary for each media library so that environmental conditions can be maintained to manage the life of the media based on a target time frame such as 10 years, 20 years, 30 years or more. dimensional stability of the written tracks can be managed by using the environmental conditions to achieve the highest data reliability and high capacities. Products can be developed so that they do not need to accommodate a wider range of environmental conditions. External sources of dust and/or debris can be reduced which would normally contaminate and/or deteriorate the media drive/tape path interface.

It is understood that although a number of different embodiments of the climate controller for automated media libraries have been illustrated and described herein, one or more features of any one embodiment can be combined with one or more features of one or more of the other embodiments, provided that such combination satisfies the intent of the present invention.

While a number of exemplary aspects and embodiments of the climate controller for automated media libraries have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A climate controller for a media library, the media library including a library interior and a media drive positioned within the library interior, the climate controller comprising:
a temperature sensor that senses an inside temperature within the library interior, the temperature sensor generating temperature information; and
a temperature controller that receives temperature information from the temperature sensor, the temperature controller controlling the temperature within the library interior based at least partially upon the temperature information, the temperature controller including one of a temperature increaser and a temperature decreaser.

2. The climate controller of claim 1 wherein the temperature controller includes one of an air conditioner, a chilled water cooler, a Peltier cooler and a vortex cooler.

3. The climate controller of claim 1 further comprising a humidity controller that controls an inside humidity within the library interior.

4. The climate controller of claim 3 wherein the humidity controller cooperates with the temperature controller to regulate an inside dew point within the library interior.

5. The climate controller of claim 3 further comprising a humidity sensor that senses the inside humidity and generates humidity information, the humidity controller controlling the inside humidity based at least in part on the humidity information.

6. The climate controller of claim 3 wherein the humidity controller includes one of a solid polymer membrane humidity controller and an ionic membrane humidity controller.

7. A media library having a library interior, the media library including the climate controller of claim 3 that controls the temperature and the humidity within the library interior.

8. The climate controller of claim 1 wherein the temperature controller selectively controls the inside temperature of the library interior based on an outside dew point that is outside of the library interior.

9. The climate controller of claim 1 wherein the temperature controller selectively adjusts the inside temperature of the library interior so that the inside temperature is greater than an outside dew point that is outside of the library interior.

10. The climate controller of claim 1 wherein the temperature controller adjusts the inside temperature within the library interior based on a predetermined schedule.

11. The climate controller of claim 1 wherein the temperature controller adjusts the inside temperature within the library interior based on a command of a user of the media library.

12. The climate controller of claim 1 wherein the temperature controller includes both a temperature increaser and a temperature decreaser.

13. A media library having a library interior, the media library including the climate controller of claim 1 that controls the temperature and the humidity within the library interior.

14. A climate controller for a media library, the media library including a library interior and a media drive positioned within the library interior, the climate controller comprising:
a humidity sensor that senses an inside humidity within the library interior, the humidity sensor generating humidity information; and
a humidity controller that is positioned at least partially within the library interior, the humidity controller controlling the humidity within the library interior based at least partially upon the humidity information.

15. The climate controller of claim 14 wherein the humidity controller includes one of a solid polymer membrane humidity controller and an ionic membrane humidity controller.

16. A media library having a library interior, the media library including the climate controller of claim 14 that controls the humidity within the library interior.

17. The climate controller of claim 14 wherein the humidity controller adjusts the inside humidity within the library interior based on a predetermined schedule.

18. The climate controller of claim 14 wherein the humidity controller adjusts the inside humidity within the library interior based on a command of a user of the media library.

19. The climate controller of claim 14 further comprising a temperature controller that controls an inside temperature within the library interior based on an outside dew point that is outside of the library interior.

20. A climate controller for a media library, the media library including a library interior and a media drive positioned within the library interior, the climate controller comprising:
a temperature sensor that senses an inside temperature within the library interior, the temperature sensor generating temperature information;
a temperature controller that receives temperature information from the temperature sensor, the temperature controller controlling the temperature within the library interior based at least partially upon the temperature information, the temperature controller including one of a temperature increaser and a temperature decreaser;
a humidity sensor that senses an inside humidity within the library interior, the humidity sensor generating humidity information; and
a humidity controller that is positioned at least partially within the library interior, the humidity controller controlling the humidity within the library interior based at least partially upon the humidity information;
wherein the humidity controller cooperates with the temperature controller to control climate conditions within the library interior based on climate conditions outside of the library interior.
